(19) United States
(12) Patent Application Publication
(10) Pub. No.: US 2024/0403932 A1
(43) Pub. Date: Dec. 5, 2024

(54) Method and system for finding an online page of a product for sale

(71) Applicants: Meir Dahan, Tveria (IL); Dmytro Orel, Dnipro (IL)

(72) Inventors: Meir Dahan, Tveria (IL); Dmytro Orel, Dnipro (IL)

(21) Appl. No.: 18/204,685

(22) Filed: Jun. 1, 2023

(51) Int. Cl. G06Q 30/0601

(52) U.S. Cl. CPC G06Q 30/0627; G06V 10/75

(57) ABSTRACT

A system method and for finding in real-time an online page of a product for sale that matches characteristic of a product shown in a digital image displayed on a screen of a computing device and for displaying on the screen of the computing device a link to that online page. The system and the method includes the receiving by the computing device or by a server the digital image or its screenshot, identifying he product in the digital image, identifying characteristic of the product, searching the internet or in a database for an online page of the product for sale that matches the characteristics, and displaying on the screen of the computing device the link to that online page.

### TECHNICAL FIELD

The present invention refers to a method for finding in real-time an online page of a product for sale that matches at least one characteristic of a product shown in a digital image displayed on a screen of a computing device and for automatic utilization as a means of advertising of the digital image viewed on a screen of a computer device.

### BACKGROUND ART

Many users of computer devices see photos or videos on their computer device in which desirable products may be shown, such as: clothes, footwear item, watches, jewelry, which the viewer is interested in purchasing. The present invention comes to answer this desire, as well as to increase the marketing possibilities of products.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts schematically the computing device.

FIG. 2 depicts in general the process of finding the offered product for sale.

FIG. 3 is a schematic depiction of the server (32) and a computing device (30) with the processing devices (31).

### THE INVENTION

The main object of the present invention is to provide a computer-implemented method (200M) for using a digital image (10) displayed on a screen (20) of a computing device (30) as a means of advertising. In fact, the computer-implemented method enables the user of the computing device to receive a link (or information) to online purchasing sources of the item that shown in the digital image on the screen of his computing device (or a similar item). By that, the method automatically utilizes digital images viewed on the screen of the computing device as a marketing platform.

The computer-implemented method enables the user of the computing device to receive a link (or information) to online purchasing sources of items that appear in the digital images on the screen of his computing device upon a special touch or click on that items in the digital images when the user feel a desire to buy such items or to get some information about them.

The term “computing device” refers in this disclosure and in the claims to any computer that has an internet connection such as smartphones, tablets, laptops, desktop computers, smart TVs, which are designed to have an internet connection.

The method is performed by processing devices (31) running on the computing device and/or on a server (32). The term “digital image” (10) in this disclosure and in the claims refers to any digital photo or digital frame of a video. The method can be applied on any photos and videos (digital images) that are viewed on the screen of the computing device.

The method of the present invention is a computer-implemented method for finding in real-time an online page of a product for sale that matches at least one characteristic of a product shown in the digital image displayed on the screen of the computing device and for displaying on the screen a link to that online page. Displaying the link on the screen of the computing device is not necessary done by writing the letters and digits of the URL (internet address) that comprises the link. It is possible to display a symbol (such as a dot or a word “to buy” or other) that will function as the link.

The method of the present invention may be implemented, for example, using a built-in app in smartphones. Thus, the built-in app may dedicate (designate) a certain shake of the phone or touch or tap or click on the screen for initiating and carrying out the method by causing the computer device to execute a screenshot, to cause the identification of the point where the user touched or clicked the screen, and transferring the screenshot to analysis in order to find the product that is identical or similar to the product on the digital image (which is of course the same as the screenshot) or even to the product on the image where the touch was made on the screen that started the process. In this case, the manufacturers of smart phones can apply the method themselves.

Another option for implementing the method (in the case of a lack of cooperation on the part of the smartphone manufacturers, cooperation needed to create a screenshot and execute the method by that special touch on the screen, which will start the execution of the method) is building an application, and when the user happens to see a photo or video with a product he likes, he simply takes a screenshot, as in normal mode, opens the application, and uploads the screenshot to it, where the method is implemented. He can touch on the screenshot (which is in fact a digital image) when the product he likes is shown for causing the method to refer the object when he touched or clicked.

The method may include the following steps:

Execute by the computing device a screenshot of the digital image that is displayed on the screen of the computing device, or uploading a digital image (can be a screenshot) to an app for processing the method. The step of (executing) taking a screenshot is only an option, not necessary, but in normal cases it is effective and preferred for implementing the invention.

Receive by the computing device or by the server the digital image or the screenshot (40) of the digital image that is viewed (displayed) on the screen upon a touch or a click on the digital image on the screen. In cases that the computing device has a touch screen it is preferably to build the method so that a touch on the screen will make the screenshot and initiate the process, and in cases when the computing device does not have a touch screen then this action can be done by clicking on the image.

After making the screenshot and receiving it (in the computing device or in the server) or receiving the digital image, the method may identify in the screenshot an object (50) in the area (60) where the touch or the click was made. Methods for identifying products in digital screenshots (digital images) are known and therefore we shall not details on this step while it is not necessary. The aim of this step is to identify the object and not necessarily the type or the kind of that object.

After identifying the object, the method identifies (by the computing device or in the server) a product (70) that the identified object constitutes. The term “product” refers in this disclosure to a wide variety of products that people use to shop, such as shoos, clothes, jewels, furniture, cars and other kind of products.

After identifying the product, the method identifies (by the computing device or in the server) at least one characteristic (80) of the identified product (70) that constitute the brand (81) of the identified item (means the brand of the item or product), a gender (82) for which the identified item is intended, a color (83) of the identified item, or the general shape of the product. In this step the method may designed to further includes steps of identifying additional characteristics such as the length of the sleeves (in case the object is clothes), the material, buttons, and unique elements that may help to find the product that constitutes this object.

After identifying the particular identified product and the characteristic of the identified product the method (by the computing device or in the server) conduct a search in the internet or in a database (90) for an online page (130) of a product offered for sale (100) that matches the at least one identified characteristic (matches the identified product). The method may find several online pages of such offered products and the method may display on the screen of the computing device links to online pages of the most similar products to that identified product.

When the method find (by the computing device or the server) the product offered for sale that matches the identified product and the at least one identified characteristic, the method may display on the screen of the computing device information (110) about the product offered for sale that was found. This information may include a photo of that product, a price, a brand or a link (120) to the online page that enables the user/viewer to go to the online page (that may be a webpage in the internet or a page in the database) where he can purchase that product or view information.

In order to achieve these goals, the method is adapted to compare images, that is, a comparison of the image of the identified object that the user touched against images on the Internet or in the database, that can be a third party database to offer products for sale for example.

In other words, the invention refers to a method for utilizing any digital image as a marketing platform (images with products in them). When a user touches the screen or clicks on the image, a screenshot is made of the digital image that is viewed on the screen. The method then automatically identifies an object in the area where the touch was made or on which the click was made, and a particular product that the identified object constitutes. At least one characteristic of the identified object is identified, that may be the brand of the identified object, the gender for which the identified object is intended, the color of the identified object, or the general shape. The method then searches the internet or the database for a product offered for sale that matches the identified product and matches the at least one identified characteristic. Finally, information about the product offered for sale that was found may be displayed on the screen of the computing device or a link to that online page.

Another objective of the present invention is to provide a computer system (200S) for using the digital image that is displayed on the screen of the computing device as the means of advertising. The computer system configured to do, by the computing device or by the server, the followings: receive the screenshot of the digital image upon a touch or a click on the digital image on the screen; identify the object in the area in the screenshot where said touch or click was made; identify the item that said identified object constitutes; identify at least one specification of the identified item that constitute the brand of the identified item, the gender for which the identified item is intended, or the color of the identified item; search the internet or in a database for a product offered for sale that matches the identified item, and matches the at least one identified specification; display information on the screen of the computing device about the product offered for sale that was found; and wherein the information includes at least a photo of said product, a price of said product, a brand of said product, or a link to a webpage where possible to purchase said product.

The method that is the subject of the invention in question, allows the use of any image as a means of finding similar products on the Internet or in databases. A person can take pictures of products in shop windows, and apply the method to them and find where these products can be purchased online.

In general the parts of the system are same to the parts and steps of the method and there is no need to repeat theme in details. In addition, methods for executing the steps stated above are known to experts in the field and therefore there is no need to describe them in details.

Another aspect of the present invention is the database (90). The entity that operates the method can establish the database, where any person who sells online and has an online sales page, can register himself in the database, upload his online page with his products to the database, and the operator (the method) will perform the search operations in the database, and will transfer links to the products listed in the database.

In summary, the present invention discloses a computer-implemented method for finding in real-time the online page of the product for sale that matches at least one characteristic of the product shown in the digital image displayed on the screen of the computing device and for displaying on the screen of the computing device the link to that online page. The term online page refers to sales pages, landing pages, websites, of a form in a database for example. The method includes the followings steps:
(A) Receiving, by the computing device or by the server, the digital image or the screenshot of the digital image.
(B) Identifying, by the computing device or by the server, the product that shown in the digital image or in the screenshot. An image recognition software can be used for identify the objects or products on the digital image or the screenshot.
(C) Identifying, by the computing device or by the server, the at least one characteristic of the product that shown in the digital image or in the screenshot.
(D) Searching, by the computing device or by the server, the internet or in the database for the online page of the product for sale that matches the at least one characteristic of the product that shown in the digital image or in the screenshot.
(E) Displaying, by the computing device or by the server, on the screen of the computing device the link to the online page that was found in the searching.

The method may further include a step of executing the screenshot upon a touch or a click on the digital image on the screen of the computing device, and that the identification of the product is designed to be done with regard to an object that is shown in an area in the screenshot where the touch or the click was made, and this object constitutes in fact the identified product. The at least one characteristic may be is a shape, a brand, or a color of the product shown in the digital image or in the screenshot or a gender for which the product is intended.

The present invention also discloses a computer-implemented method for managing the database (90) of a plurality of online pages (130) of products for sale (100) that is saved on the server (32). This method includes the following steps: (A) Receiving, by the server from computing devices of sellers (140), requests to include the plurality of online pages of products for sale in the database. (B) Storing, in the database on the server, the plurality of online pages of products for sale. (C) Receiving, by the server from the computing device of the user (30), a request to conduct the search in the database. (D) Searching, by the server in the database, the online page of the product for sale that matches the at least one characteristic of the product that shown in the digital image displayed on the screen of the computing device of the user. Image recognition program can be used for searching and fining the proper online page with the product for sale. Examples of product characteristics are size, shape, weight, color, quality, hardness, etc. The list of product characteristics depends on the product and how its functional design requirement is defined. (E) Sending, by the server to the computing device of the user, the link to the online page of the product for sale that was found in that searching.

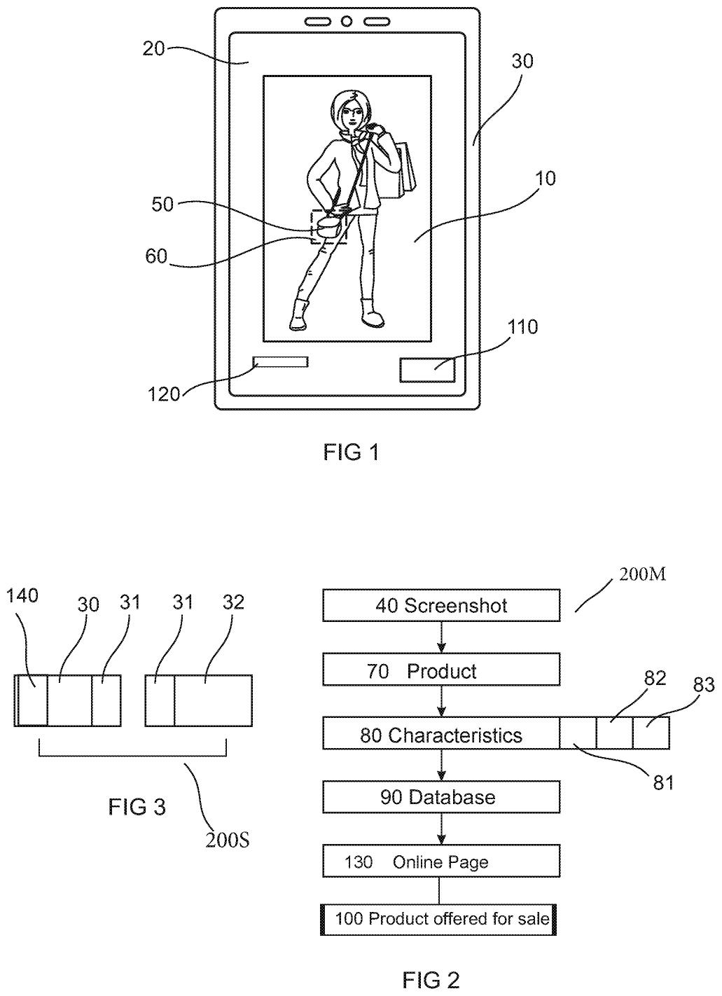

FIG. 1 depicts schematically the computing device. FIG. 2 is a flow chart that depicts in general several steps of the process of the method (200M). FIG. 3 is a schematic depiction of system (200S) that includes the server (32) and a computing device (30) with the processing devices (31).

The screenshot may be performed upon a touch or a click on the digital image on the screen. The computer-implemented method may perform the identification of a product that is shown in the area in the digital image or in the screenshot, where a touch or a click on the screen was made. Preferably, that a designated touch or a designated click on the digital image displayed on the screen will initiate the performance of the computer-implemented method. The designated touch or the designated click that initiates the performance of the computer-implemented method or the computer system may be a part of the operating system program of the computing device.

Another special aspect of the present invention is the use of an image that happens to appear on the screen, without it being related to the system or the method, or to the person that operates the system or the method, and this image that happens to be displayed on the screen is used as a means of triggering, and searching and finding products sold online. For example, the user can view on his mobile phone photos of his travel with friends on a fishing trip they took years before. The user sees in one of the images a watch on the wrist of his travel companion; the user can touch the screen on the watch, and the system and method will display a link where such a watch can be purchased online. That is, the digital image mentioned above is an unrelated image.

What is claimed is:

1. A computer-implemented method for finding in real-time an online page of a product for sale that matches at least one characteristic of a product shown in a digital image displayed on a screen of a computing device and for displaying on the screen of the computing device a link to that online page, said computer-implemented method comprising:
receiving, by the computing device or by a server, the digital image or a screenshot of the digital image;
identifying, by the computing device or by the server, the product that shown in the digital image or in the screenshot;
identifying, by the computing device or by the server, the at least one characteristic of the product that shown in the digital image or in the screenshot;
searching, by the computing device or by the server, the internet or in a database for the online page of the product for sale that matches the at least one characteristic of the product that shown in the digital image or in the screenshot;
displaying, by the computing device or by the server, on said screen of said computing device the link to the online page found in said searching.

2. The computer-implemented method of claim 1 wherein said screenshot is performed upon a touch or a click on said digital image on said screen.

3. The computer-implemented method of claim 1 wherein said identified product is shown in an area in said digital image or in said screenshot, where a touch or a click on said screen was made.

4. The computer-implemented method of claim 1 wherein a designated touch or a designated click on said digital image displayed on said screen is designed to initiates a performance of said computer-implemented method.

5. The computer-implemented method of claim 4 wherein said designated touch or said designated click that initiates said performance of said computer-implemented method is a part of an operating system program of said computing device.

6. The computer-implemented method of claim 1 wherein said at least one characteristic is a shape, a brand, or a color of said product shown in said digital image or said screenshot or a gender for which said product is intended.

7. A computer system for finding in real-time an online page of a product for sale that matches at least one characteristic of a product shown in a digital image displayed on a screen of a computing device and for displaying on the screen of the computing device a link to that online page, said computer system is configured to:
receive, by the computing device or by a server, said digital image or a screenshot of said digital image;
identify, by the computing device or by the server, the product that shown in the digital image or in the screenshot;
identify, by the computing device or by the server, the at least one characteristic of the product that shown in the digital image or in the screenshot;
search, by the computing device or by the server, the internet or in a database for the online page of the product for sale that matches the at least one characteristic of the product that shown in the digital image or in the screenshot;
display, by the computing device or by the server, on said screen of said computing device the link to the online page that was found in said searching.

8. The computer system of claim 7 wherein said screenshot is performed upon a touch or a click on said digital image on said screen.

9. The computer system of claim 7 wherein said identified product is shown in an area in said digital image or in said screenshot, where a touch or a click on said screen was made.

10. The computer system of claim 7 wherein a designated touch or a designated click on said digital image displayed on said screen is designed to initiates a performance of said computer system.

11. The computer system of claim 10 wherein said designated touch or said designated click that initiates said performance of said computer system is a part of an operating system program of said computing device.

12. The computer system of claim 7 wherein said at least one characteristic is a shape, a brand, or a color of said product shown in said digital image or said screenshot or a gender for which said product is intended.

13. A computer-implemented method for managing a database of a plurality of online pages of products for sale that is saved on a server, the computer-implemented method comprising:
receiving, by the server from computing devices of sellers, requests to include the plurality of online pages of products for sale in the database;
storing, in the database on the server, said plurality of online pages of products for sale;
receiving, by the server from a computing device of a user, a request to conduct a search in the database;
searching, by the server in the database, an online page of a product for sale that matches at least one characteristic of a product that shown in a digital image displayed on a screen of the computing device of the user;
sending, by the server to the computing device of the user, a link to the online page of a product for sale that was found in said searching.
